(19) United States
(12) Patent Application Publication
(10) Pub. No.: US 2025/0018589 A1
(43) Pub. Date: Jan. 16, 2025

(54) Pet Protector and Rescue Tool

(71) Applicant: Stephen P. Souders, Lenhartsville, PA (US)

(72) Inventor: Stephen P. Souders, Lenhartsville, PA (US)

(21) Appl. No.: 18/221,494

(22) Filed: Jul. 13, 2023

(51) Int. Cl. A01K 27/00; A62B 3/00; B26D 5/10; B26D 7/00

(52) U.S. Cl. CPC B26D 5/10; A01K 29/00; A62B 3/005; B26D 7/0006

(57) ABSTRACT

A system for extrication of a pet from a strap of a pet collar or harness by a rescuer in the event of an emergency including one or more pet rescue tools mounted onto and around selected portions of one or more straps of the collar or harness at predetermined positions for use in cutting the straps of the collar or harness in the event of entanglement of the pet with life threatening possibilities. The pet rescue tool is provided with a tamper indicator, handle retention member and guide paths for maintaining the cutting implement in perpendicularity while cutting across the strap to release the pet from the entanglement.

### BACKGROUND OF THE INVENTION

It seems dog collars get caught on many things, and strangulation by collar has even caused some dogs to lose their lives. Dog collars getting entangled, caught or stuck on fixed objects or other dogs happens so often that large pet retail companies created break-away collars to prevent this from happening. One thing is certain, large companies will not spend thousands of dollars creating a new, safer item unless it fills a need and a buying niche.

This is not to say a dog will strangle itself by just wearing a collar. However, it is possible a dog will be strangled by its collar if the collar becomes entangled with a fixed object and taking a few steps to make sure that this result does not happen to a dog is worth its weight in gold.

One example of a dog being strangled by a collar can occur while two dogs are playing together. Both dogs are wearing secured collars when one dog playfully pulled on the other dog's collar. The playful dog's muzzle suddenly became tangled in the other dog's collar. The tangled dog will likely panic and start pulling away which will cause the other dog (the one wearing the tangled collar around its neck) to choke. The tangled collar will likely cause the strangling of the dog as the other dog continues to pull away. Only the release of the entanglement, or the cutting of the tangled collar, will relieve the life-threatening situation.

Many pet-related businesses have strict rules about removing collars in certain situations. It is believed to be mandatory in veterinary clinics to remove all collars from any patient kenneled, even during a hospital stay. Large retail grooming chains also have strict polices requiring dog collars to be removed before dogs are placed in their kennels. Needless to say, there has certainly been a trend in dog collar accidents and attempts to alleviate their occurrence.

Dogs should wear a collar under supervision only. That means the dog's collar should be removed whenever the dog is crated, playing with another dog, or left unsupervised in your home. It is just not worth the risk of potential strangulation or other injury. If you're not comfortable with your dog running around naked, i.e., no collar, there are a few break-away collars on the market. Break-away collars look and feel just like regular flat buckle collars and feature a spot for ID tags too. The difference is break-away collars will unsnap and free your dog when it snags onto or becomes entangled with a fixed object.

Over the last 15 years, break-away collars have vastly improved. Originally, the break-away mechanism was super sensitive. If a dog sneezed while wearing its collar, the collar would unsnap. Today, break-away collars are a great safety option. Most are versatile and have two D-rings that can be used during leash walks, which disables the break-away option. Once the leash is removed, the break-away collar option resumes.

Collars that are tangled or caught on an external object can be extremely dangerous to dogs. The result from being tangled or caught has been associated with the following injuries: whiplash, fainting, spinal cord injuries, paralysis, crushing of the trachea, partial or complete asphyxiation, crushing or fracture of the bones in the larynx, dislocation of the vertebrae in the neck, bruising of the esophagus, damage to the skin and tissue of the neck, prolapsed eyeballs, or brain damage. The entanglement of dog collars on other dogs or fixed objects can also lead to sudden death. How does collar strangulation happen? Collar strangulation, or collar suffocation, occurs when a pet's collar gets caught on an object, fence or even another pet and while attempting to get away, the collar tightens around its neck restricting air flow that can result in asphyxiation or additional damage to various anatomical structures or nerve damage.

Collars or other pet restraint devices, e.g., harnesses, require either a break-away option or another safety device to permit the removal of the collar or harness without the need to unbuckle or otherwise unfasten the collar. Unfastening may not be possible in the event of a panicked animal or if suffocation is imminent or the fastener is under so much stress that it becomes unworkable. In any of these circumstances the cutting of the collar or harness strap is the quickest and most efficient method of releasing the pet from the imminent harm of strangulation or other physical injury.

The present invention is meant to be affixed to a pet restraint, e.g., collar or harness, in such location as to facilitate the quick severing of the strap of the collar or harness to free the pet from the life or injury threatening situation. It is an object of the present invention to provide such quick escape from the life or injury threatening situation by being mounted to a strap of the collar or harness a rescue tool being capable of instantly cutting that strap to free the pet from the collar or harness and the possible imminent harm.

It is also an object of the present invention to provide a rescuer with a cutting tool pre-positioned at a location on the collar or harness strap to extricate the pet from the collar or harness safely and without the need to use a knife or other cutting implement that may not be readily available. It is a further object of the present invention to provide a collar or harness mountable escape device that is easily manipulatable by anyone to cut through the collar or harness strap and free the pet. It is a still further object of the present invention to allow for varying widths of the collar or harness strap and to allow for the placement and relocation of the escape device once mounted onto the strap of the collar or harness to afford maximum comfort for the pet.

An additional object of the present invention is to provide the strap cutting tool in a safe and/or retracted position within the rescue tool so that neither the pet or the user will be harmed or injured during normal use. It is also an additional object of the present invention to achieve mounting in any desired position on the safety harness by creating a space for the encompassing of the strap of the collar or harness where the space is commensurate with the width and thickness of the strap so that the pet rescue tool remains in the desired position affording a measure of comfort to the pet.

It is a still further object of the present invention to eliminate the possibility of entanglement by a hanging identification tag by including such information on the top, either side or underside of the rescue tool. Another object is to provide a compact lightweight rescue tool that will not interfere with any normal activity in which the pet engages. Other objects will appear hereinafter.

### SUMMARY OF THE INVENTION

A system for extrication of a pet from a collar or harness of varying types utilizing a pet rescue tool is described as being pre-positioned in any desired location onto one or more straps of the collar or harness. The pet rescue tool may be used with any collar or harness and is further described as being pre-positioned in any location easily accessible by the rescuer along the strap of the collar or harness for extrication of the pet from a life-threatening entanglement by a rescuer without resorting to an external cutting implement.

The pet rescue tool has a housing including first and second sections. The first or upper section has a recess dimensioned to permit a strap of a pet collar or harness to be positioned therein. The second or lower section is connected to the upper section at a rear portion of both the first and second sections by a hinge. The two sections are fixedly joinable together at their respective front portions to capture the strap of the pet collar or harness between the two sections and frictionally maintain the position of the pet rescue tool on the captured portion of the strap. The pet rescue tool also is described as having a position locking mechanism between the respective front portions of both the first and second sections of the tool that retains the two sections in juxtaposed contact once engaged.

The upper section houses a cutting implement and cutting guide for severing the safety belt or harness webbing captured between the two sections. The cutting guide is located within a guide track for maintaining the cutting guide and associated cutting implement in substantially perpendicular alignment to the captured strap of a collar or harness. The guide track extends within the upper section from the rear to the front and has both upwardly and downwardly opening slots. The downwardly opening slot permits the forward sliding of the cutting implement and the upwardly opening slot permits the attachment of the cutting guide to a handle for operating the cutting implement attached to the cutting guide.

The handle section is connected at a rear portion of both the first section by a pin extending through the handle section and captured by both halves of the first section. The handle is also connected to the cutting guide by the same pin extending through the cutting guide with the pin permitting the handle to move from a stowed to an operational position. The handle is maintained in its stowed position by a retaining member.

The first and second sections house in an elongated space created between the attached first and second sections a cutting implement and cutting guide for severing the strap of either a collar or harness captured between the first and second sections. The cutting guide is located within a guiding track for maintaining the cutting guide and associated cutting implement in substantially perpendicular alignment to the captured strap of the collar or harness. The guiding track extends within the elongated space between the halves of the first section from rear to front and having both upwardly and downwardly opening slots. The downwardly opening slot permits the forward sliding of the cutting implement and the upwardly opening slot permits the attachment of the cutting guide to the handle for operating the cutting implement attached to the cutting guide.

Based upon the description contained herein, the pet recue tool will be readily available for use by a rescuer as it will be retained in position on the strap of the collar or harness of the types described herein at the pre-positioned locations until needed.

The invention described following is a system for extrication of a pet from a collar or harness by a rescuer in the event of an emergency. The invention can be described as including one or more pet rescue tools pre-positioned on a similar number of sections of straps arrayed about the collar or harness to facilitate the cutting of such straps with all of the pet rescue tools being accessible to the rescuer at all times. Each of the pet rescue tools includes a housing comprising first and second sections, the first section having a strap capturing recess dimensioned to permit the strap of the collar or safety harness to be positioned therein. The two sections are connected to each other at their rear portions by a hinge and both sections are fixedly joined together at their respective front portions to capture a portion of said strap of the collar or harness between the two sections and frictionally maintain the position of the tool on the captured portion of the strap. The first section also houses a cutting implement and cutting guide for severing the strap of the collar or harness captured between the two sections. The cutting guide is located within paired upper and lower guiding tracks for maintaining the cutting guide and the cutting implement in substantially perpendicular alignment to the edge of and across said strap. The paired guiding tracks extend within the first section from rear to front with the upper guiding track having an upwardly opening slot and the lower guiding track having a downwardly opening slot. The downwardly opening slot permits the forward sliding of the cutting implement and the upwardly opening slot permits the attachment of the cutting guide to a handle for operating the cutting implement attached to the cutting guide.

The first section also houses a lower cutting guide having position extensions extending inwardly to maintain the cutting guide in perpendicular alignment to the edges of the strap of the collar or harness and also includes a guide slot extending across the base portion of the second section for maintaining the cutting implement in perpendicular alignment to the edges of the strap of the collar or harness regardless of external forces exerted against the cutting implement or pet rescue tool. The handle is attached to the cutting guide by a rotatable pin located between the sides of the first section and extending into the upper guiding track permitting the handle and the cutting guide to move from a stowed to an operational position with the handle being maintained in the stowed position by a retaining member such that the pet rescue tool is readily available for use as it is retained in its pre-positioned location on the strap of the pet collar or harness.

The strap capturing recess of the pet rescue tool has dimensions that are sized in accordance with the thickness and material composition of the strap of the collar or harness. The tamper indicator and retaining member for maintaining the handle in the stowed position is a fracturable cover with breakaway flanges extending into cooperating recesses in either side of the first section along its top. The retaining member for maintaining the handle in the stowed position will resists fracture until an exerted force is in excess of at least 10 pounds. The retaining member additionally acts as a tamper indicator in extending over the handle such that when broken or missing tampering or prior use is indicated.

The pet rescue also includes a strap capture position locking mechanism between the respective front portions of both the first and second sections of the combination tool that retains the two sections in juxtaposed contact once engaged. In addition, the pet rescue tool includes one or more strap spacing members for retaining the strap of the collar or harness in a predetermined position within the strap capturing recess.

The handle of the pet rescue has a specially shaped gripping end that is T-shaped to facilitate an easier grip by the rescuer to release the handle and to cut through the strap of the collar or harness. The strap capture recess dimensions are sized in accordance with the thickness and material composition of the strap of the collar or harness with a thicker strap having a cutout of similar length dimension to the width of the pet rescue tool to facilitate the capture of a thicker strap within the recess of the pet rescue tool.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a perspective view of a dog with the pet rescue tool of the present invention attached to a collar.

FIG. 2 is a perspective view of a dog with the pet rescue tool of the present invention attached to a harness.

FIG. 3 is a perspective view showing the top of the present invention.

FIG. 4 is a perspective view showing the bottom of the present invention.

FIG. 5 is a perspective view showing the collar or harness strap (in phantom) with the pet rescue tool of the present invention in an open condition to accept the strap.

FIG. 6 is an exploded view of the lower section of the present invention.

FIG. 7 is a sectional view of the present invention taken along Line 7-7 of FIG. 3.

FIG. 8 is a sectional view of the present invention taken along Line 8-8 of FIG. 7.

FIG. 9 is a sectional view of the present invention taken along Line 9-9 of FIG. 7.

FIG. 10 is a sectional view of the present invention taken along Line 10-10 of FIG. 7.

FIG. 11 is a sectional view of the present invention taken along Line 11-11 of FIG. 7.

FIG. 12 is an enlarged view of the uppermost portion of FIG. 11 showing the tamper indicator and handle retention member engaged into the sidewalls in its normal position.

FIG. 13 is an enlarged view of the rightmost portion of FIG. 12 showing the tamper indicator and handle retention member engaged into the sidewall in its normal position.

FIG. 14 is an enlarged view of the rightmost portion of FIG. 12 showing the tamper indicator and handle retention member partially removed as the handle is moved to its operational position.

FIG. 15 is a perspective view of the top of the tamper indicator and handle retention member of the present invention.

FIG. 16 is a perspective view of the bottom of the tamper indicator and handle retention member of the present invention.

FIG. 17 is a sectional view of the tamper indicator and handle retention member of the present invention taken along Line 17-17 of FIG. 15.

FIG. 18 is a sectional view of the present invention showing the handle lifted into engaged mode for cutting and the blade moved forward with the tamper indicator and handle retention member exploded outward from its position holding the handle in a stowed condition.

FIG. 19 is a perspective view of the present invention showing the upper portion of the pet rescue tool lifted to show a spacer forcing the collar or harness strap (in phantom) to the rear of the cutting surface.

FIG. 20 is a side view of the present invention showing the spacer forcing the collar or harness strap (in phantom) to the rear of the cutting surface.

FIG. 21 is a perspective view of the present invention showing the handle lifted to show a front and a rear spacer forcing the collar or harness strap (in phantom) to the center of the cutting surface.

FIG. 22 is a side view of the present invention showing the front and rear spacers forcing the collar or harness strap (in phantom) to the center of the cutting surface.

FIG. 23 is a sectional view (similar to FIG. 10) showing an alternate thicker collar or harness strap cut down to retain the present invention in position within the cutdown section of the strap.

FIG. 24 is a perspective view of the bottom surface of the present invention showing a plurality of recesses or pockets with a cap exploded outward from one recess or pocket for containing an electronic chip therein.

FIG. 25 is a partial sectional view of the bottom surface of the present invention showing the cap and its retained chip being press fit within the desired pocket.

FIG. 26 is a partial sectional view of the bottom surface of the present invention showing the cap and its retained chip being held in position by a snap fit within the desired pocket.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings where the invention is described in connection with a pet circumscribing strap of a collar or harness system.

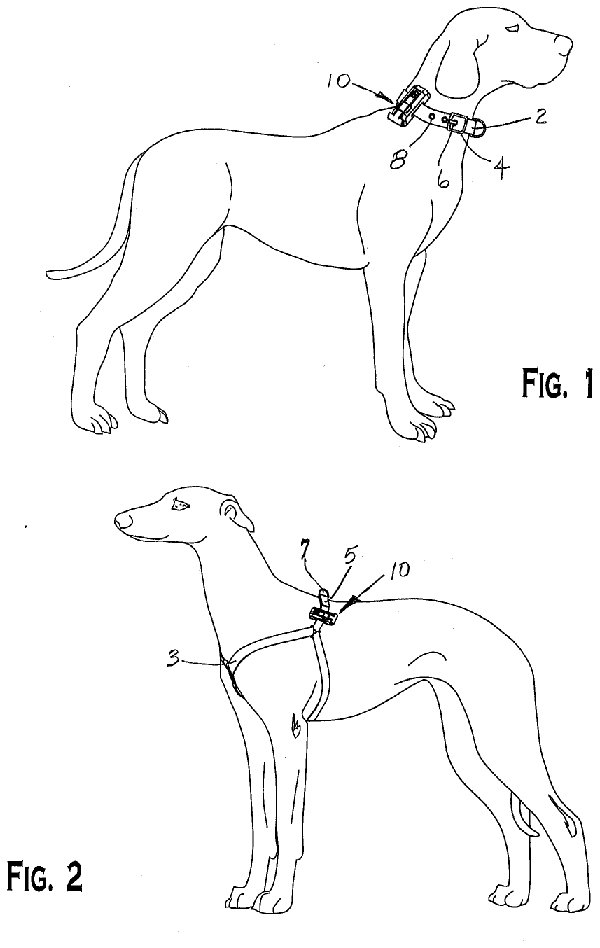

Referring now to the drawings in detail, where like numerals refer to like parts or elements, there is shown the pet rescue tool 10 of the present invention. In FIG. 1 the pet rescue tool 10 is shown mounted to a pet collar strap 2 that is secured about the neck portion of the pet by an adjustable buckle frame 4 with the prong 6 fitting through any of a plurality of apertures to accommodate the proper circumference of the neck portion of the pet. In FIG. 2, the pet rescue tool 10 is shown mounted to an upper portion of a pet harness 3 that is secured about the chest portion of the pet by passing the strap 5 through a plurality of D-rings 7 along the back of the pet to hold the harness in proper position.

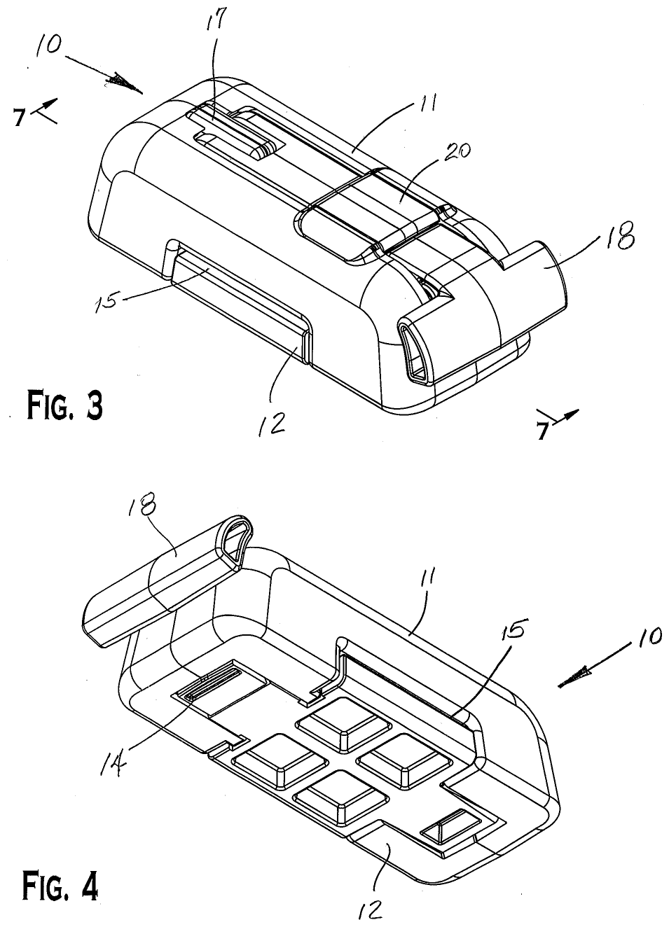

Referring now to FIGS. 3-5, the pet rescue tool 10 is shown mounted onto and around pet collar strap 2 or the pet harness strap 3. This mounting is accomplished by placing the pet collar strap 2 or the pet harness strap 3 between an upper portion 11 and a lower portion 12 of the pet rescue tool 10 that are separated by a hinge pin 13 located at one end of the combined tool 10. At the other end of the pet rescue tool 10 there is a snap lock mechanism 14 that will retain the two portions 11, 12 of the pet rescue tool 10 together once engaged. The snap lock mechanism 14 can be any device or apparatus that can be engaged by inserting an extended piece or protrusion located on the upper portion 12 of the pet rescue tool 10 into a cooperating opposing receiver located on the lower portion 11 of the pet rescue tool 10 to operatively engage one with the other to retain the two portions 11, 12 in immediate adjacent proximity of one to the other. One example of such a snap lock mechanism is an appendage 14A extending outward from the lower portion 12 of the pet rescue tool 10 having an extended distal lip for insertion into and engagement with a cooperating recess and opposing lip 14B in the upper portion 11 of the pet rescue tool 10 having a shape that fully mates with the lip-like appendage for engaging with the entire length of the appendage so as to capture all of the appendage within the cooperating recess and retain the entire appendage within the recess holding the two portions 11, 12 of the pet rescue tool 10 together in a substantially parallel alignment. This engaging of appendage 14A within the cooperating recess and opposing lip 14B results in the pet collar strap 2 or the pet harness strap 3 being surrounded and captured within a recess 15 between the two portions 11, 12 of the pet rescue tool 10.

The recess 15 in the upper portion 11 has a depth substantially the same as the thickness of the pet collar strap 2 or the pet harness strap 3 for capturing said strap between the top of the recess 15 located in the upper portion 11 against the opposing surface or central base 30 of the lower portion 12. The closure of the upper and lower portions 11, 12 together creates sufficient frictional contact of the pet rescue tool 10 against the pet collar strap 2 or the pet harness strap 3 to maintain the pet rescue tool 10 in the desired position along either type of strap.

Once engaged around the pet collar strap 2 or the pet harness strap 3 the pet rescue tool 10 is still capable of being positioned into a more desired location along the strap. However, once the upper and lower portions 11, 12 of the pet rescue tool 10 are in engaged juxtaposition there is considerable friction between the inside surfaces of the upper and lower portions 11, 12 of the pet rescue tool 10 and either type of strap. Although there is frictional contact, the pet rescue tool 10 is still capable of being repositioned along the portion of the pet collar strap 2 or the pet harness strap 3 onto which it was placed such that the pet rescue tool 10 can be located or relocated into a more comfortable position for use by the pet as needed.

The upper portion 11 of the pet rescue tool 10 houses the cutting implement 16 that is attached to a cutting guide 17. The cutting guide 17, in turn, is attached to a handle 18 that can be best described as having a base portion 18A and a gripping portion 18B. The base portion of the handle 18A is attached to the cutting guide 17 by pin 19. Pin 19 is free to rotate and travel within cooperating recesses, i.e., an upper guide path 21, located in each of the respective side portions 11A, 11B of the upper portion 11. Pin 19 enables the gripping portion 18B of the handle 18, formed into a T-shaped gripping end, to be positioned between approximately a 60° and a 90° position to the outer surface of the upper portion 11 of the pet rescue tool 10.

The handle 18 is retained in a stowed position by a position retaining member 20 approximately midway along the length of the handle 18 that is configured to overlie and engage with cooperating recesses along each side 11A, 11B of upper portion 11 of the pet rescue tool 10. Engagement of the retaining member 20 within the recesses maintains the handle 18 in the stowed position until pulled outward and upward for use in cutting through the strap 2, 3 by the cutting implement 16.

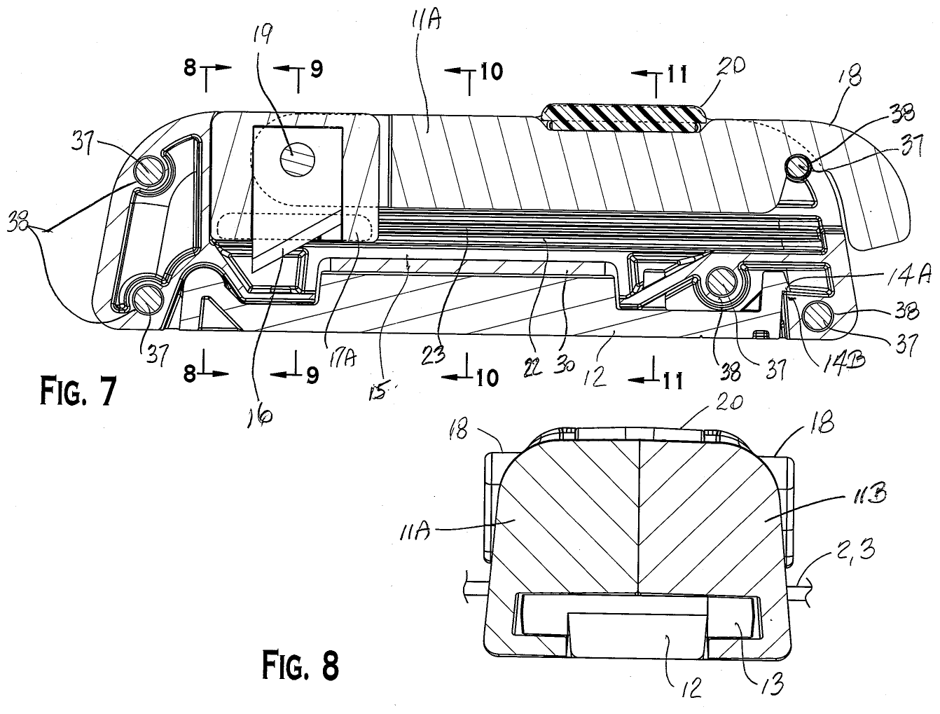

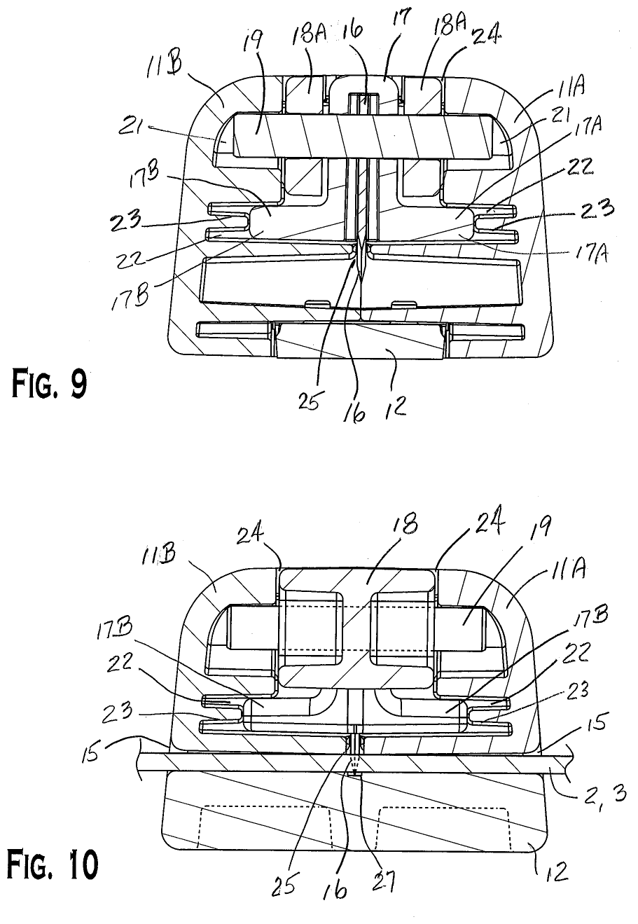

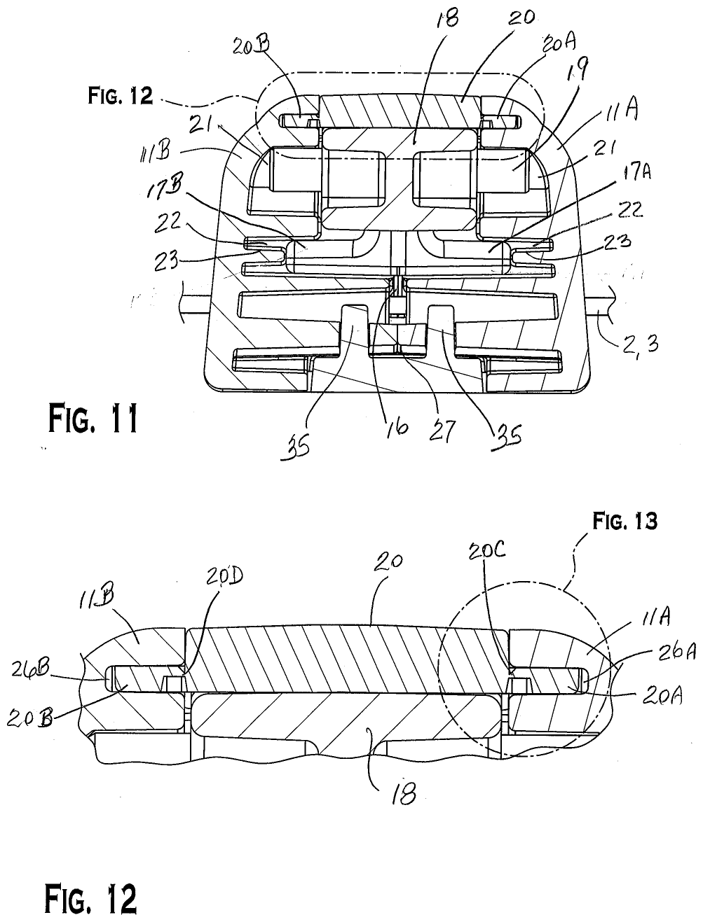

Also housed within the upper portion 11 of the combined tool 10 is the cutting implement 16. The cutting implement 16 is stored at the rear of the pet rescue tool 10 within a recess that serves as a lower guide path 22 for moving the cutting implement 16 from the rear to the front of the pet rescue tool 10 along a predetermined pathway, which movement results in the cutting through of the strap 2, 3. The lower guide path 22 extends from the rear to the front of the upper portion 11 of the pet rescue tool 10 (within each of the sides 11A, 11B) and houses both the cutting guide 17 and the attached cutting implement 16 as best shown in FIGS. 6, 7 and 9-11. The lower outward extending flanges 17A, 17B of cutting guide 17 and the cutting implement 16 are always housed within lower guide path 22 of the pet rescue tool 10 and remain completely unexposed to the exterior of the pet rescue tool 10 once engaged onto the strap 2, 3.

The upper and lower guide paths 21, 22, partly housed respectively within each side 11A, 11B of the upper portion 11, are configured to allow the free forward movement of the cutting guide 17 and cutting implement 16 once the handle is 18 is disengaged from its stowed position along the top of the upper portion 11. Upper guide path 21 has parallel upper and lower walls dimensioned to accommodate the distal ends of pin 19 that connects the upper portion of the cutting guide 17 and the base 18A of handle 18 together allowing the free forward and rearward motion of the cutting guide 17 and handle 18. Lower guide path 22 also has parallel upper and lower walls to slidingly accommodate each of the lower outward extending shoulders 17A, 17B of cutting guide 17 and to maintain the alignment of the cutting guide 17 within inwardly extending alignment members 23 affording the same free forward and rearward motion in conjunction with the handle 18. The upper and lower guide paths 21, 22 act together to maintain the alignment of the handle 18, cutting guide 17 and cutting implement 16 in a parallel relationship to the length dimension of the pet rescue tool 10 and substantially perpendicular to the edges of the strap 2, 3. Due to the compactness of the pet rescue tool 10, the parallel, vertically aligned and spaced apart guide paths 21, 22 function as a unit to maintain the alignment of the cutting implement 16 attached to the cutting guide 17 in a centrally positioned alignment between each of the sides 11A, 11B of the upper portion 11 of the pet rescue tool 10.

The cutting guide 17 as connected to the handle 18 extend through an elongated slot 24 located along and formed between the length of the sides 11A, 11B such that the handle 18 can be manipulated to pull the cutting guide 17 and cutting implement 16 along the guide paths 21, 22 and cut through the strap 2, 3. Connecting the lower guide path 22 with the recess 15 below the upper portion 11 is an elongated slot 25 extending between the sides 11A, 11B from the rear to the front of the upper portion 11 of the pet rescue tool 10. Extending through elongated slot 25 is the attached cutting implement 16. There is also a guide path extension 27 of the lower guide path 22 located in the in the central base 30 of the lower portion 12 of the pet rescue tool 10 that is used to maintain the distal end of the cutting implement 16 in a straight orientation regardless of forces exerted against the cutting implement 16 by the strap 2, 3 or other external forces. The guide path extension 27 is directly beneath, aligned with, and coextensive to the elongated slot 25 which completes the lower guide path 22. The dimensional tolerances or clearance distances between the walls of the lower guide path 22, the internal alignment members 23, and the exterior surfaces of the lower outwardly extending flanges 17A, 17B of cutting guide 17 and attached cutting implement 16 are relatively small to allow for ease of movement while maintaining the predetermined and desired pathway of the cutting implement 16 perpendicular to the edge of and across the strap 2, 3. These small dimensional tolerances between and among the enumerated elements of the guide paths 21, 22 result in a more accurate cut across the strap along the shortest possible distance.

When the handle 18 is removed from the stowed position by popping the tamper indicator and handle retention member 20 outward and upward, the handle 18 is in its operating position to move the cutting implement 16 along the upper and lower guide paths 21, 22 to cut through the strap 2, 3. With the handle 18 and its gripping end 18B in the upright position, pulling force can be applied against the cutting guide 17 so that the pet rescuer can pull the cutting guide 17 and attached cutting implement 16 away from the rear of the pet rescue tool 10 along the upper and lower guide paths 21, 22 toward the front of the pet rescue tool 10. The handle gripping end 18B is T-shaped in order to more easily facilitate the rescuer in releasing the handle 18 and in gripping the handle 18 and moving the attached cutting guide 17 and cutting implement 16 forward along the guide paths 21, 22.

The guide paths 21, 22 have upper and lower slots 24, 25 extending the length of the upper portion 11 to enable the connection of the handle 18 to the cutting guide 17 through the upper slot 24 and the operation of the cutting guide 17 and cutting implement 16 through lower slot 25 to contact and cut the strap 2, 3. As the cutting implement 16 and cutting guide 17 traverse upper and lower guide paths 21, 22, lower slot 25, and guide path extension 27, the strap 2, 3 is cut through creating separated segments of a pet collar or harness resulting, generally, in the strap 2, 3 being severed apart. With the cutting and segmentation of strap 2, 3, the pet rescue tool 10 can be disengaged from the remnants of the collar or harness.

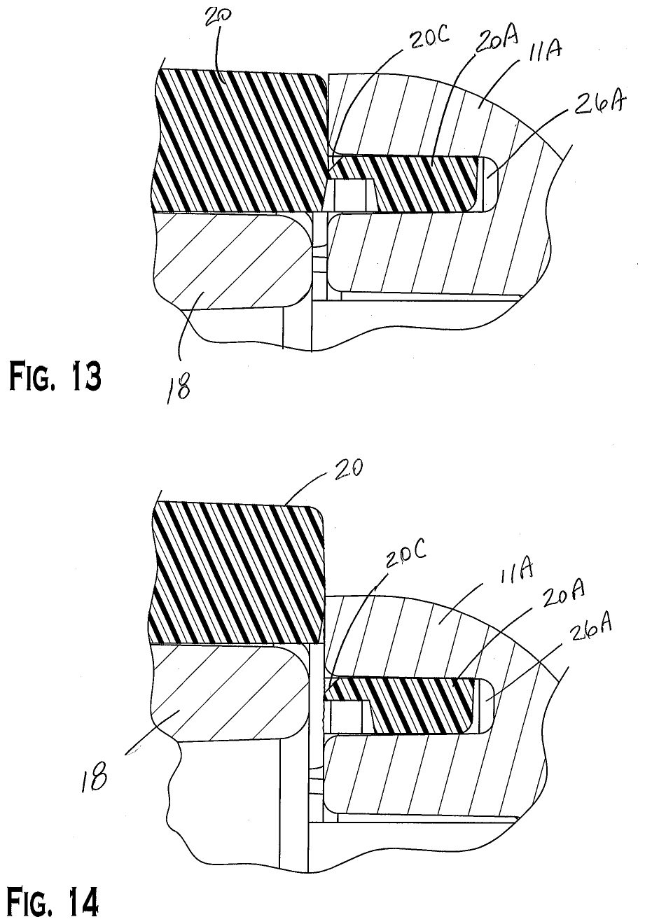

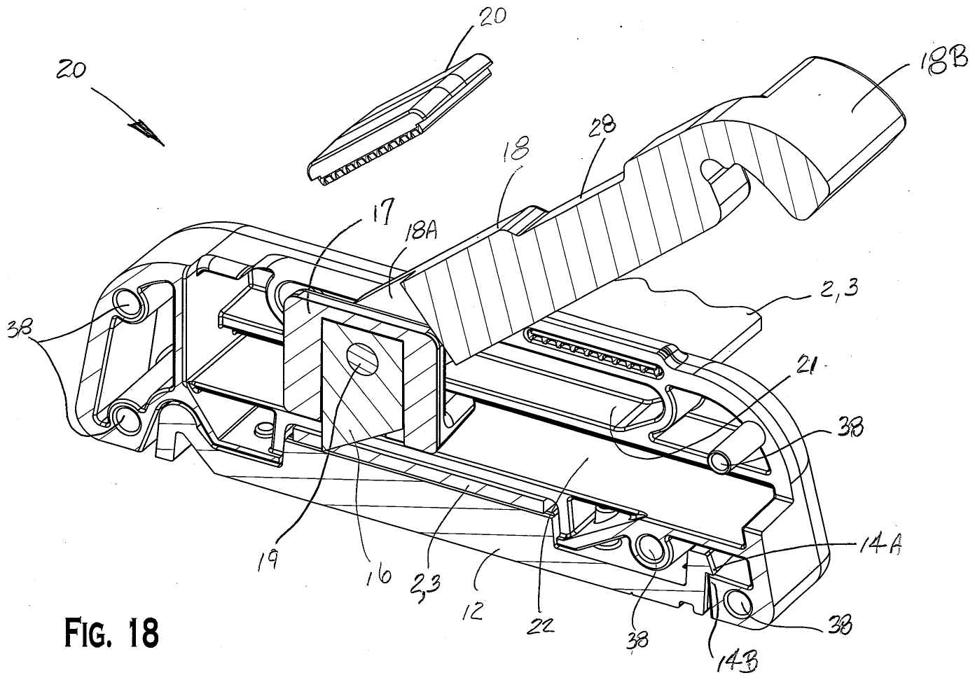

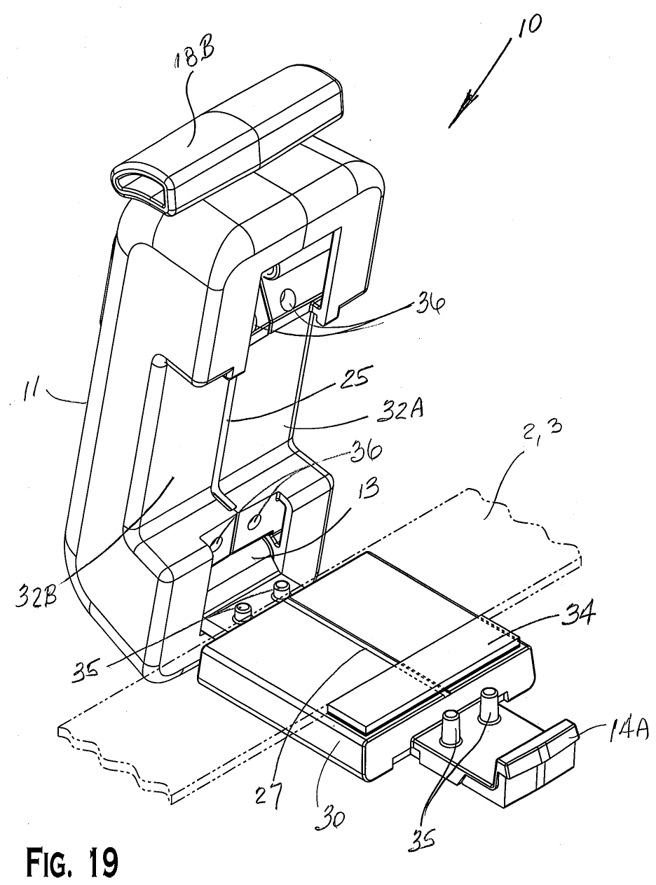

Referring to FIGS. 12-17, the tamper indicator and handle retention member 20 is positioned across the top of handle 18 spanning across the upper slot 24 extending between the right and left sides 11A, 11B of the upper portion 11 of the pet rescue tool 10. The handle retention member 20 has opposite side outwardly extending flanges 20A, 20B that fit within mating recesses 26A, 26B in each side 11A, 11B of the upper portion 11 of the pet rescue tool 10. Each flange 20A, 20B is connected to the main body of the handle retention member 20 by a narrowed connector 20C, 20D such that when outward, upward force is applied to the handle retention member 20 both of the flanges 20A, 20B will separate from the main body of handle retention member 20 causing the retention member 20 to fall away from the pet rescue tool 10 releasing the handle 18 from its stowed position. This action of pulling the handle gripping end 18B upward away from the body of the pet rescue tool 10 can be more readily seen by viewing an enlargement of one side of the handle retention member 20 as shown in FIGS. 13, 14. FIG. 13 depicts the handle retention member 20 in the handle stowed position. FIG. 14 depicts the handle 18 being moved upward fracturing the narrowed connector 20C between the main body of retention member 20 and the flange 20A with the flange 20A remaining within the recess 26A and the handle retention member 20 being moved upward and outward from the pet rescue tool 10 releasing the handle 18 from its stowed position.

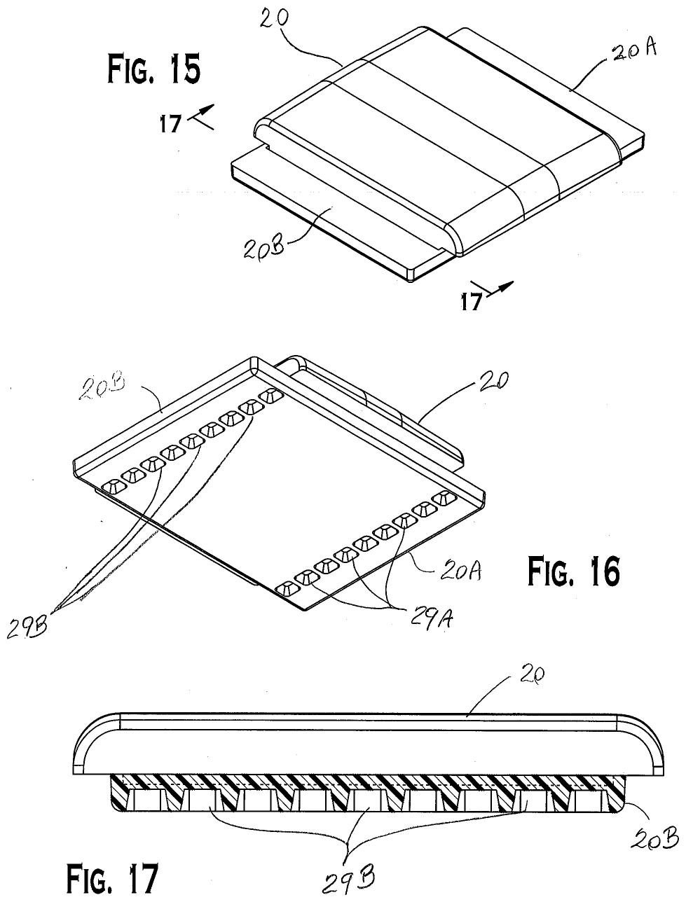

FIGS. 15-17 depict the tamper indicator and handle retention member 20 separated from the remainder of the pet rescue tool 10 to show the mechanism by which the retention member 20 can be separated from the upper surface of the handle 18 and upper portion 11 of the pet rescue tool 10. The two flanges 20A, 20B extend laterally outward from the main body of the handle retention member 20 with a series of cutouts 29A, 29B extending along a fracture line beneath the top surface of each flange 20A, 20B at their respective junctions with the main body of the handle retention member 20. Each of the cutouts 29A, 29B extend almost entirely through the flanges 20A, 20B with the inward facing wall of each of the cutouts 29A, 29B coinciding vertically with the outward facing wall of the handle retention member 20 creating a weakened breakaway or fracture line enabling an easier separation when the handle 18 is desired to be moved to its operating position. The force required for the fracturing of the handle retention member 20 is in the range of 10-15 lbs. of upward force.

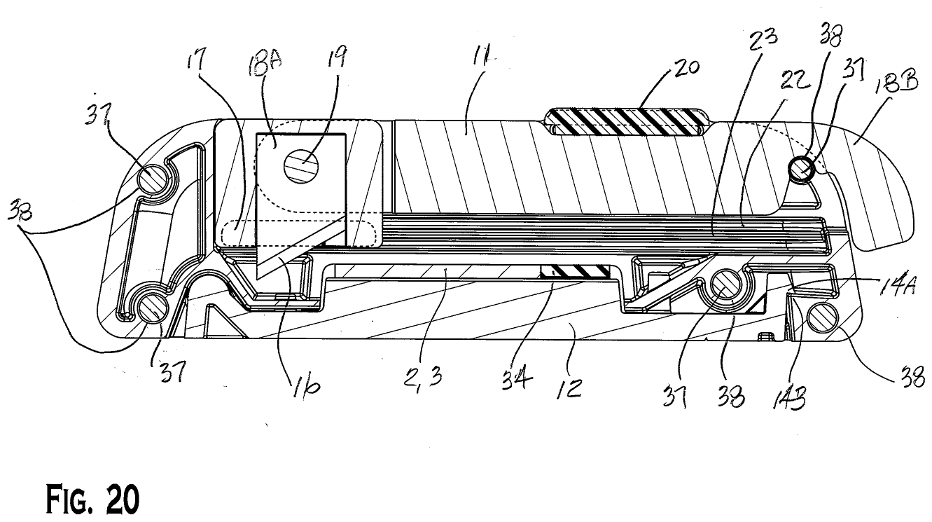

Referring now to the cutaway view of FIG. 18, the upper and lower portions 11, 12 of the pet rescue tool 10 are juxtaposed against each other and the handle 18 has been moved to its operating position. In moving the handle 18 from its stowed position to its operating position tamper indicator and handle retention member 20 has been broken and exploded outward away from the pet rescue tool 10. Prior to its manual removal from atop the handle 18 of the pet rescue tool 10 the retention member 20 rested against a correspondingly shaped and sized depression 28 in the top surface of the handle 18.

A better view of the latching of the upper portion 11 to the lower portion 12 is depicted with the opposing lip extensions 14A, 14B overlying each other to retain the upper and lower portions 11, 12 in immediate contact with each other and capture the strap 2, 3 between them within the recess 15. In this view the cutting implement 16 has already been moved forward from its stowed position in conjunction with the cutting guide 17 and depicts a partially cut strap 2, 3.

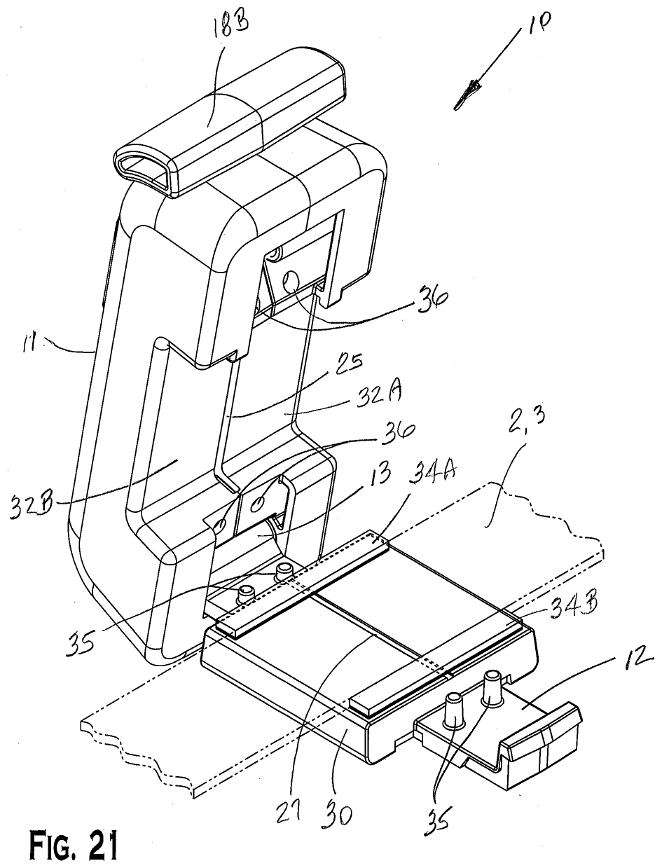

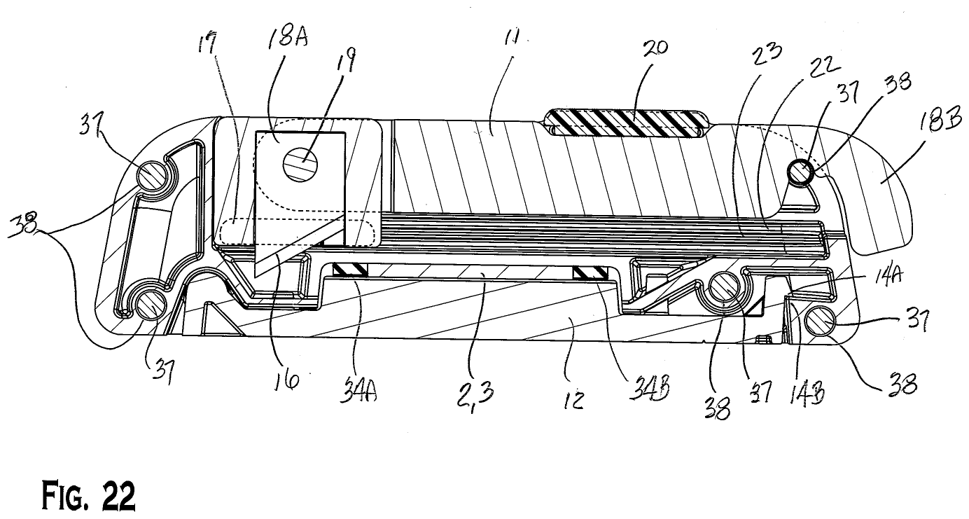

In the event that the strap 2, 3 has a width dimension that is less than the full width of the recess 15 when positioned within the pet rescue tool 10, a positional spacer 34 is placed next to the strap 2, 3 within recess 15 and atop the central base 30 of lower portion 12. See, FIGS. 19, 20. Spacer 34 is preferred to be placed to the forward end of pet rescue toll 10 to permit the cutting of the strap 2, 3 prior to the possible cutting of the spacer 34. This is but one possible position for a spacer that is placed within recess 15 to retain the strap 2, 3 in its desired position within the pet rescue tool 10. One alternative is to position strap 2, 3 in a centered position within recess 15 of the pet rescue tool 10 with spacers 34A, 34B positioned on either side as shown in FIGS. 21, 22. The spacers 34A, 34B have a total width equivalent to the width of spacer 34 to fill the remaining space of recess 15 not occupied by strap 2, 3 to retain the strap in the desired position within recess 15 of pet rescue tool 10. Thus, spacers 34A, 34B do not necessarily need to be the same width, as shown in FIGS. 21, 22, but can be of differing width dimensions with the sole requirement being that the combined width of the spacers fills the remaining space of recess 15 adjacent strap 2, 3. The same requirement will exist for a single spacer, e.g., spacer 34, in that it will be required to fill the remaining space unoccupied by strap 2, 3 within recess 15 of pet rescue tool 10. The spacers 34, 34A, and 34B are preferred to have the same height as strap 2, 3 and can be retained in their respective positions using an adhesive tape that is adhered to the base 30 in the appropriate position.

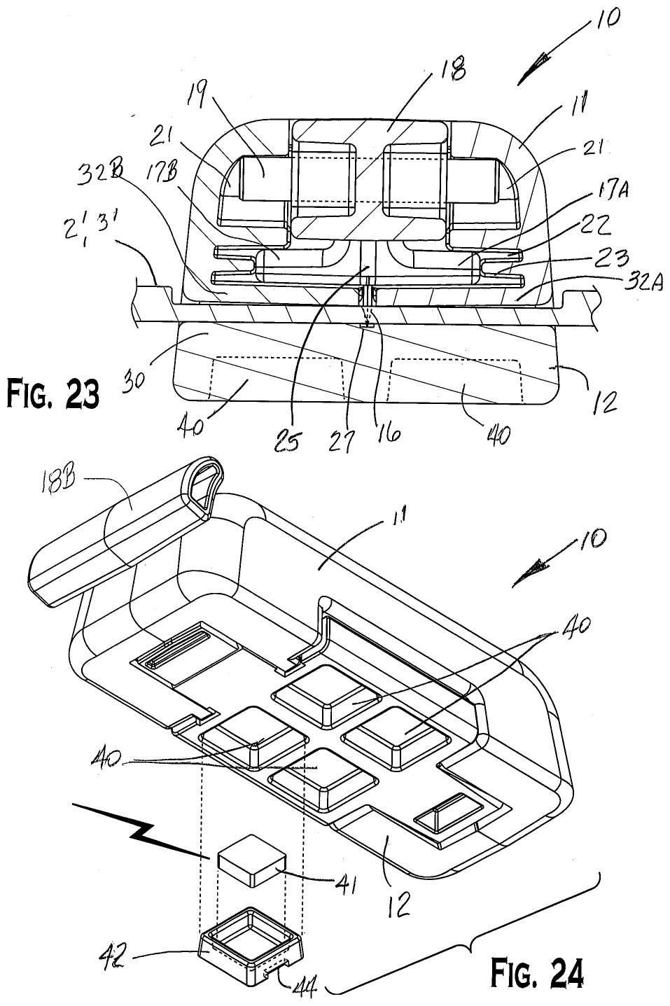

A different method of retaining the pet rescue tool 10 in its desired position on the strap 2, 3 is to reduce the thickness of the strap 2, 3 at the location for preferred placement of the pet rescue tool 10 as shown in FIG. 23. In this embodiment, the strap 2′, 3′ is reduced in thickness to fit the allowed height requirements of the recess 15 a distance equal to the width of the pet rescue tool 10 so that when snapped in place the pet rescue tool 10 remains within the area of reduced thickness of the strap 2, 3 and does not depend entirely on frictional contact between the pet rescue tool 10 and strap 2, 3 for position retention.

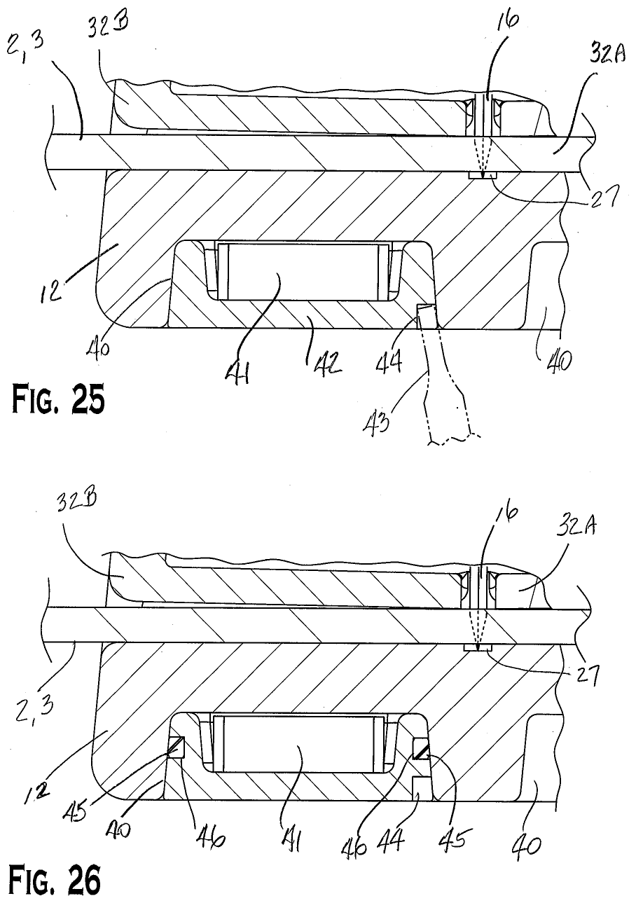

Referring to FIGS. 24-26, the pet rescue tool 10 includes a number of uniform depressions or recesses 40 arrayed across the underside of lower portion 12 in a side-by-side quad-array. Each of the recesses 40 can be fitted with a cap or closure 42 that is dimensioned to be tightly press fit into the recess 40. A digitized memory and passive communication device 41 in the form of a microchip can be placed within any recess 40 and retained therein by cap 42. Memory and passive communication device 41, the microchip, can contain owner, pet and veterinary information, etc. that can be loaded onto the microchip 41 directly or through a Wi-Fi or Bluetooth® communications pathway well known in the art. As the device is passive, one need only interrogate the microchip 41 utilizing a standard protocol such as a rf scan to retrieve the information contained on the memory within microchip 41. The memory and passive communication device (microchip) 41 can be press fit into the cap 42 and retained therein until such time as removal is required for replacement, memory or program updates, or destruction. Cap 42 can be pried away from its press fit closure into recess 40 using any tool 43 that will fit into slot 44 in cap 42 such that the cap can be moved outward and away from recess 40 exposing device 41. Alternatively, cap 42 can be fit into recess 40 by attaching it between opposing lateral elongated protrusions or bars 45 extending into the recess 40 from the sidewalls using a tool, such as 43, pressed against and/or into slot 44 that will flex cap 42 to slightly bend and accept the lateral bars 45 into corresponding recesses 46 located along sidewalls adjacent to the bars 45 located in cap 42 as shown in FIG. 26.

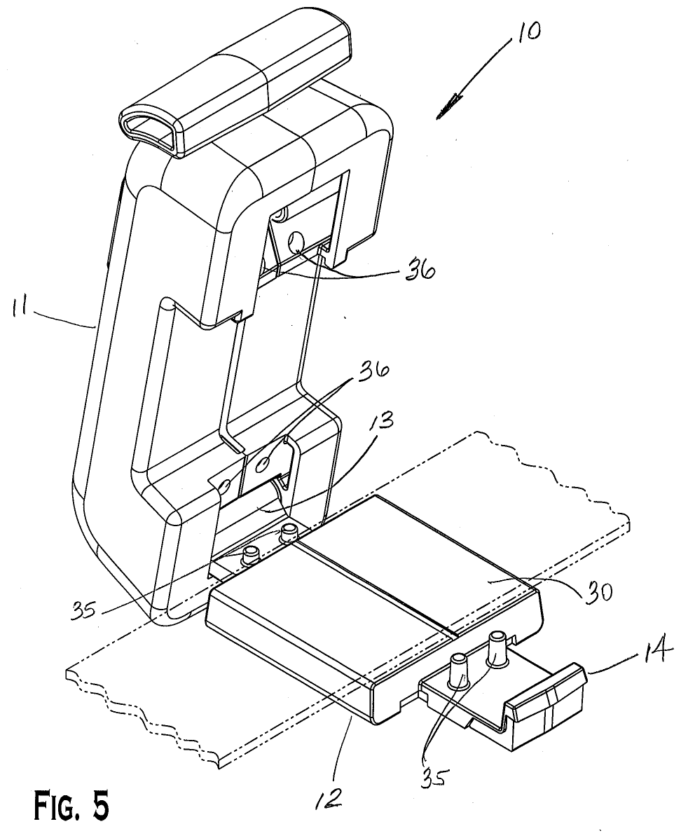

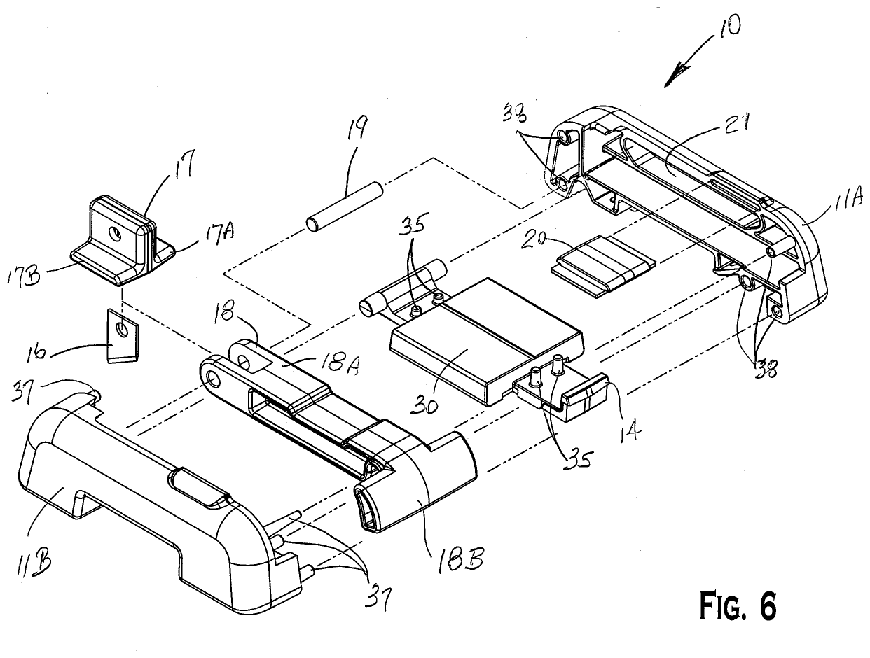

Referring back to FIGS. 5, 6, 11, 19 and 21 there are several protrusions or pegs 35 arrayed in sets of two pegs that extend outward and upward from lower portion 12 which are positioned to cooperate with and be retained within receptacles 36 of corresponding sets of two receptacles located in upper portion 11. The pegs 35 and receptacles 36 add to the structural integrity of pet rescue tool 10 by preventing portions of the tool from moving laterally away from their respective desired positions. In addition, regarding FIGS. 6, 7, 18, 20 and 22 there are several protrusions or pegs 37 arrayed in sets of two or three that extend inward from one half of upper portion 11, i.e., 11B, toward a like number of receptacles 38 of corresponding sets of two or three receptacles located in the other half of upper portion 11, i.e., 11A. Likewise, pegs 37 and receptacles 38 add to the structural integrity of pet rescue tool 10 by preventing portions of the tool from moving vertically away from their respective desired positions. All of the pegs 35, 37 are preferred to have a taper lock fit with the corresponding receptacles 36, 38.

In order not to interfere with the daily activities of any pet that is intended to wear the pet rescue tool 10 on its collar or harness, the tool 10 has been crafted to be relatively small and compact in dimension while not losing its ability to slice through the strap 2, 3 of either a collar or a harness. The overall dimensions of the tool 10 are preferred to be approximately 2.75 inches in length, 1.125 inches in width and 0.875 in height. It is believed that keeping with these preferred dimensions there will not be any impact on the daily lives of any pet wearing the pet rescue tool 10. Nor will there be any impact on the movement of the pet, e.g., play, sleep, exercise, etc. due to the small size of the pet rescue tool 10. Also, the weight of the pet rescue tool 10 has been kept between 1 and 2 ounces (approximately 30 grams) to reduce any adverse impact on the pet regardless of the weight or size of the pet. Neither can the handle be inadvertently opened due to the necessary force of in excess of approximately 12 lbs. to break away the retention member 20 such that the handle 18 is unable to become entangled in anything the pet brushes up against or moves through.

In summary, in the event of a pet entanglement, the pet rescue tool 10, having been prepositioned on a selected portion of the strap 2, 3 of either a collar or harness, can be used to cut through the strap and free the pet from the entanglement. The cutting action is initiated by releasing the handle 18 of the pet rescue tool 10, grasping the handle 18, positioning it upright in a substantially perpendicular postilion to the remainder of the pet rescue tool 10, and pulling the handle 18 forward along the guide paths 21, 22, causing the cutting implement 16 to cut through the strap 2, 3 at the location of the pet rescue tool 10. Once the strap 2, 3 has been cut and the collar or harness has fallen away the pet should be freed from whatever entanglement was threatening the life of the pet. In this way any person seeing a pet entangled in a life-threatening situation can easily cut through the strap 2, 3 of either a collar or a harness freeing the pet from the entanglement.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A system for extrication of a pet from a collar or harness by a rescuer in the event of an emergency comprising:
one or more pet rescue tools pre-positioned on a similar number of sections of straps arrayed about the collar or harness to facilitate the cutting of such straps, all said pet rescue tools being accessible to the rescuer at all times;
said pet rescue tool comprising:
a housing comprised of first and second sections, said first section having a strap capturing recess dimensioned to permit the strap of the collar or harness to be positioned therein, said two sections connected to each other at their rear portions by a hinge, and both sections being fixedly joinable together at the respective front portions thereof to capture a portion of said strap of the collar or harness between the two sections and frictionally maintain the position of the tool on the captured portion of the strap;
said first section housing a cutting implement and cutting guide for severing the strap of the collar or harness captured between the two sections, said cutting guide being located within paired upper and lower guiding tracks for maintaining the cutting guide and the cutting implement in substantially perpendicular alignment to the edge of and across said strap, said paired guiding tracks extending within the first section from rear to front thereof with said upper guiding track having an upwardly opening slot and said lower guiding track having a downwardly opening slot, said downwardly opening slot permitting the forward sliding of the cutting implement and the upwardly opening slot permitting the attachment of the cutting guide to a handle for operating the cutting implement attached to the cutting guide;
said first section also housing a lower cutting guide having position extensions extending inwardly to maintain the cutting guide in perpendicular alignment to the edges of the strap of the collar or harness;
said lower cutting guide also including a guide slot extending across the base portion of the second section for maintaining the cutting implement in perpendicular alignment to the edges of the strap of the collar or harness regardless of external forces exerted against the cutting implement or pet rescue tool;
said handle being attached to said cutting guide by a rotatable pin located between the sides of the first section and extending into the upper guiding track permitting the handle and the cutting guide to move from a stowed to an operational position, said handle being maintained in the stowed position by a retaining member,
whereby said pet rescue tool is readily available for use by being retained in its pre-positioned location on the strap of the pet collar or harness.

2. The pet rescue tool of claim 1, wherein said strap capturing recess dimensions are sized in accordance with the thickness and material composition of the strap of the collar or harness.

3. The pet rescue tool of claim 1, wherein said retaining member for maintaining the handle in the stowed position being a fracturable cover with breakaway flanges extending into cooperating recesses in either side of the first section along the top thereof.

4. The pet rescue tool of claim 3, wherein said retaining member for maintaining the handle in the stowed position resists fracture until force is exerted in excess of at least 10 pounds of force.

5. The pet rescue tool of claim 1 further comprising a strap capture position locking mechanism between the respective front portions of both the first and second sections of the pet rescue tool that retains the two sections in juxtaposed contact once engaged.

6. The pet rescue tool of claim 2, further comprising one or more strap spacing members for retaining the strap of the collar or harness in a predetermined position within said strap capturing recess.

7. The pet rescue tool of claim 1, wherein the gripping end of the handle is T-shaped to facilitate an easier grip by the rescuer to release the handle and to cut through the strap of the collar or harness.

8. The pet rescue tool of claim 1, wherein said recess dimensions are sized in accordance with the thickness and material composition of the strap of the collar or harness with a thicker strap having a cutout of similar length dimension to the width of the pet rescue tool to facilitate the capture of a reduced thickness of the strap within the recess of the pet rescue tool.

9. The pet rescue tool of claim 1, wherein the retaining member additionally acts as a tamper indicator in extending over the handle such that when broken or missing tampering or prior use is indicated.

10. The pet rescue tool of claim 1, further comprising a plurality of recesses on the underside of said tool for housing and retaining at least one microchip containing identifying information for the pet, said microchip being retained within a selected recess by a removeable covering.
